(19) United States
(12) Patent Application Publication
(10) Pub. No.: US 2010/0238943 A1
(43) Pub. Date: Sep. 23, 2010

(54) COMMUNICATION CHANNEL SWITCH

(75) Inventor: Koji HIRAYAMA, Yokohama (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/633,359

(22) Filed: Dec. 8, 2009

(30) Foreign Application Priority Data
Mar. 19, 2009 (JP) 2009-067531

(51) Int. Cl. H04L 12/56; H04N 7/173

(52) U.S. Cl. 370/401; 725/109

(57) ABSTRACT

The URLs and priority levels of a plurality of frequently accessed sites are stored beforehand in a user registration table in a communication channel switch. The communication channel switch stores the start time and end time of the latest access and the elapsed time at the site, in an access history table. The communication channel switch changes the priority levels in the user registration table in accordance with the length of the elapsed time. The communication channel switch collects video data from the sites prior to the time recorded as the latest access start time in the access history table, in accordance with the priority level in the user registration table, and stores the video data in a storage unit in the switch. When the user accesses a site included in the user registration table, the communication channel switch provides the site information in the storage unit quickly.

### CLAIM OF PRIORITY

The present application claims priority from Japanese patent application JP 2009-067531 filed on Mar. 19, 2009, the contents of which are hereby incorporated by reference into this application.

### BACKGROUND OF THE INVENTION

1. Field of the Invention

The present invention relates to communication channel switches, and more specifically, to a communication channel switch suitable as a connection apparatus to one or more access points, among an unspecified large number of access points (access destinations) provided on a communication network such as the Internet.

2. Description of the Related Art

As the Internet grows, Internet access tools, which were personal computers at the beginning, have diversified into mobile phones and Internet Protocol television receivers (IPTVs). Many browsers incorporated in the IPTVs have a specific website as its fixed portal site.

### SUMMARY OF THE INVENTION

The above-described browsers incorporated in the IPTVs are not configured to allow the users to make any modifications. From the point of view of network service providers, this mechanism blocks direct access to their websites from the users. From the point of view of the users who want to receive a service, the mechanism is an obstacle to their direct access to a desired site and lowers the value of the service because it requires time, for example.

Browsing by the IPTV differs from browsing by a personal computer or a mobile phone in that most of the information to be viewed at sites are video. Since the volume of traffic on the communication channel is much larger than the amount of information mainly formed of text and still images at conventional sites, fast and stable supply of information is desired. The IPTV users expect information to appear on the screen the moment they operate their remote control or the like, like the usual television broadcast. The same speed is required in the Internet access.

A portal redirection function is provided to allow the user to access a site other than the specific website. The function allows the user to access directly a website provided by a service provider. When the web browser accesses a website first, the function sends a HyperText Markup Language (HTML) file that causes redirection to the specific site. When the user opens the web browser, the function redirects the user to the single specific site forcibly and gives the user no other choice. The problem cannot be solved. In “Provider Trial Method, Program, and System” disclosed in Japanese Unexamined Patent Application Publication No. 2003-296473, the user is initially allowed to view a plurality of sites in a short period of time and is finally allowed to access just a single site. Once the site is specified, the user cannot access a different site.

Methods used to display information on the screen the moment when the remote control or the like is operated, as in usual television broadcast, include “Method for Collecting Homepage Data in Internet” disclosed in Japanese Unexamined Patent Application Publication No. 2000-315171. With this method, an automatic tour of URLs specified in advance is made to collect information, and the information is stored in a cache server, so that the wait time can be reduced. If the user specifies many URLs, the amount of information increases, increasing the volume of traffic on the communication channel. The storage capacity of the cache server must be increased accordingly.

A collection method disclosed in “Cache Device” in Japanese Unexamined Patent Application Publication No. 2001-318902 collects data at intervals calculated from the number of times access is made. If video is viewed mainly, as with the IPTV, the viewing time or operation time at a single site is longer than that with the personal computer or mobile phone. The number of times access is made does not simply indicate the frequency at which the user views the information at the site, and ineffective collection can be carried out. The technologies of history management and cache management disclosed in Japanese Unexamined Patent Application Publication No. 2008-197858, No. 2006-196008, No. 2004-280405, and No. 2000-276425 are provided for PCs, mobile phones, and personal digital assistants (PDAs) and do not consider the reception of video, which is a main feature of the IPTV.

Accordingly, it is an object of the present invention to provide a communication channel switch that makes it possible to display quickly on an IPTV the information of a site having a URL selected from URLs listed in advance. Another object of the present invention is to reduce the storage capacity of a storage unit for storing video data in a communication channel switch.

An object of the present invention is to provide a communication channel switch in which the URLs of one or more providers of a service the user wants to receive are specified in advance, the connection switching apparatus being disposed on a communication channel and collecting the minimum necessary video information beforehand in accordance with the specified URL, asynchronously with user's request, on the basis of information such as user's preference, expected access time, and past access elapsed time at the site. An object of the present invention is to allow the user to quickly view the information of a desired site, irrespective of the fixed URL information specified in the IPTV, by accumulating video information in the connection switching apparatus.

An object of the present invention is to reduce the access time by predicting a site access request from the user and reading ahead site information data requested by the user, in accordance with the access request.

An object of the present invention is to use the storage capacity of the storage unit efficiently by collecting data if the access end time is within a predetermined period and preventing unnecessary site information data from being collected.

To solve the above-described problems, the URLs and priority levels of a plurality of frequently accessed sites are stored in advance in a registration table in a communication channel switch according to the present invention. In addition to the registration table, an access history table is provided in the communication channel switch. The table holds the start time and end time of the latest access and an elapsed time at the site. If the elapsed time is long and if the access end time is within a predetermined period, the user's preference to the site is determined to be high, and the priority level of the registration table is changed accordingly.

The communication channel switch next specifies the order in which information data is collected from sites that are expected to be accessed by the user, in accordance with the priority level of the registration table. The site information data is collected prior to the time recorded as the start time of the latest access in the access history table and are stored in a storage unit in the communication channel switch. By doing this, information in the storage unit can be provided when the user accesses the site stored in the registration table.

The communication channel switch of the present invention connects communication equipment owned by a user to the Internet or a public communication network and performs authentication and other processing. The communication channel switch has a table for storing connection destination information specified in advance by the user and a table for recording a history concerning the connection destination. The communication channel switch also has a function to collect the information of a plurality of servers provided on the public communication network and an area where the information is recorded, so that the information can be transmitted at a high speed between the communication equipment and the servers and the communication channel can be used effectively.

The present invention relates to a method, using the communication channel switch described above, for connecting the communication equipment and a plurality of servers provided on the public communication network and collecting the information of the servers wherein, the information is collected before a predicted user's request is made, by using the connection destination information specified by the user. When the user makes a request, the communication channel switch provides the information of the servers without obtaining the information directly from the servers and performs the processing to connect the communication equipment.

According to the solving means of the invention, there is provided a communication channel switch disposed between a receiver which obtains video from a communication network and displays the video and the communication network which has connection destination sites, the communication channel switch comprising:

an access history storage unit which stores in advance an elapsed time from the start to the end of past access to each of the sites, in association with identification information of the sites;

a video data storage unit which stores video data obtained from the sites; and

an operation unit;

the operation unit determining the priority levels of the sites in accordance with the elapsed time in the access history storage unit;

obtaining video data from each of the sites in descending order of priority levels of the sites and storing the video data in the video data storage unit in association with the identification information of the sites; and

when an access request which includes identification information of a connection destination site is received from the receiver, reading the video data corresponding to the identification information from the video data storage unit and outputting the data to the receiver.

According to the present invention, it is possible to provide a communication channel switch that makes it possible to display quickly on an IPTV the information of a site having a URL selected from URLs listed in advance. According to the present invention, it is possible to reduce the storage capacity of a storage unit for storing video data in a communication channel switch.

According to the present invention, it is possible to provide a communication channel switch in which the URLs of one or more providers of a service the user wants to receive are specified in advance, the connection switching apparatus being disposed on a communication channel and collecting the minimum necessary video information beforehand in accordance with the specified URL, asynchronously with user's request, on the basis of information such as user's preference, expected access time, and past access elapsed time at the site. According to the present invention, it is possible to allow the user to quickly view the information of a desired site, irrespective of the fixed URL information specified in the IPTV, by accumulating video information in the connection switching apparatus.

According to the present invention, it is possible to reduce the access time by predicting a site access request from the user and reading ahead site information data requested by the user, in accordance with the access request.

According to the present invention, it is possible to use the storage capacity of the storage unit efficiently by collecting data if the access end time is within a predetermined period and preventing unnecessary site information data from being collected.

### BRIEF DESCRIPTION OF THE DRAWINGS

FIG. 1 is a diagram showing the structure of a system of an embodiment.

FIG. 2 shows an example of information displayed on the screen of an IPTV in the embodiment.

FIG. 3 is a block diagram of a communication channel switch 103.

FIG. 4 is a diagram showing the structure of a user registration table 400 in the communication channel switch 103.

FIG. 5 is a diagram showing the structure of an access history table 500 in the communication channel switch 103.

FIG. 6 is a flowchart illustrating an overview of processing.

FIG. 7 is a flowchart illustrating processing to add a URL to the user registration table.

FIG. 8 is a flowchart illustrating video data collection from a registered site.

FIG. 9 is a flowchart illustrating an access start operation.

FIG. 10 is a flowchart illustrating an access continue operation.

### DESCRIPTION OF THE PREFERRED EMBODIMENTS

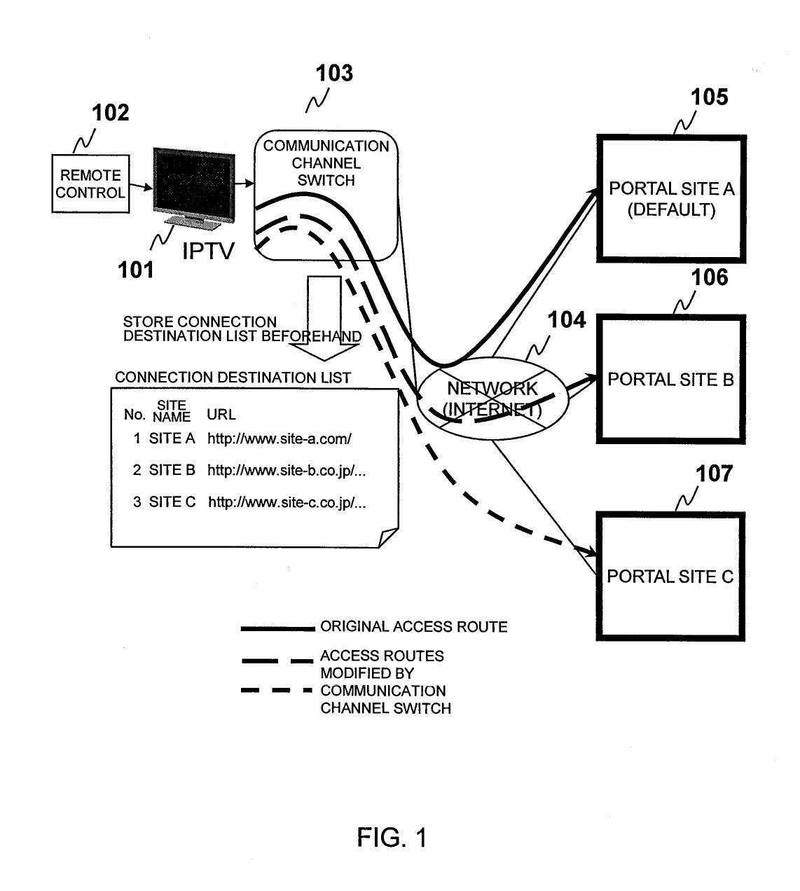

FIG. 1 is a diagram showing the structure of an Internet network system to which a communication channel switch of an embodiment is applied.

The system includes an Internet Protocol television receiver (IPTV) 101 which allows the user to view information of websites, a remote control 102 with which a series of operation and text information can be input, a communication channel switch 103, a communication network 104, such as a public network and the Internet, and a portal site A 105, a portal site B 106, and a portal site C 107 for providing a variety of information. The IPTV 101 usually has the URL of a specific site as the basic information in an internally provided web browser and, while the communication channel switch 103 is not connected, accesses the specific site automatically. FIG. 1 shows a state in which the URL of the portal site A 105 is specified as default information in the IPTV 101 and the site is accessed. Although there can be an infinite number of sites that provide information on the Internet, FIG. 1 shows just three sites, the portal site A 105, the portal site B 106, and the portal site C 107, for convenience of explanation.

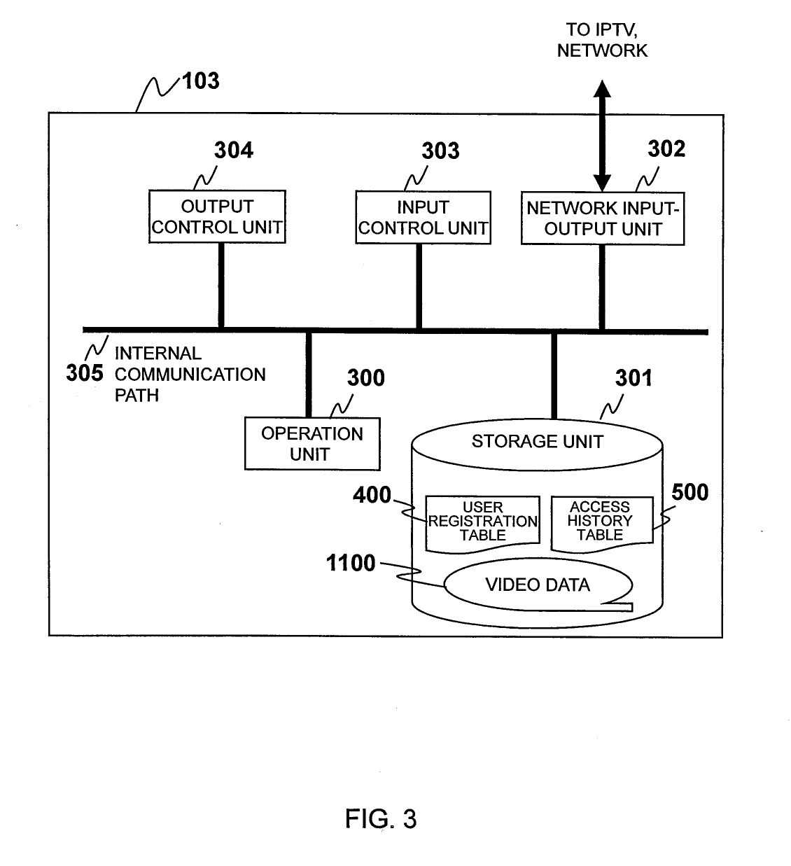

FIG. 3 is a functional block diagram of the communication channel switch 103.

The communication channel switch 103 includes an operation unit 300 for controlling the entire switch, a storage unit 301 to and from which each functional block writes and reads information, an output control unit 304 for controlling information output to a display unit such as the IPTV 101, an input control unit 303 for controlling information input from the remote control 102 through the IPTV 101, a network input-output unit 302 for controlling communication between the communication channel switch 103 and an external network unit (such as the IPTV 101 or a unit inside the network 104), and an internal communication path 305 for information communication between functional blocks. The storage unit 301 includes a user registration table (user registration information storage unit) 400, an access history table (access history storage unit) 500, and a video data storage unit 1100.

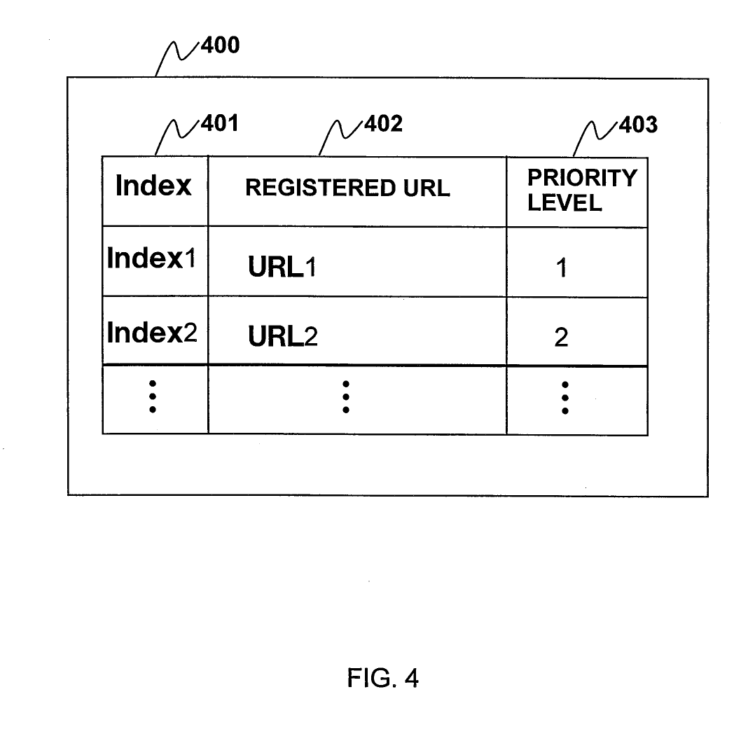

FIG. 4 is a diagram showing the structure of the user registration table 400 in the communication channel switch 103.

The user registration table 400 is a data table storing an index 401, a registered URL (identification information or address information of a connection destination site) 402, and a priority level 403 in association with one another. The index 401 is identification information of an entry (a combination of the registered URL 402 and the priority level 403) in the user registration table 400, such as a sequential number or text. The index 401 may be omitted. The registered URL 402 indicates the URL of a connection destination portal site. The priority level 403 is determined according to the elapsed time at the site indicated by the registered URL.

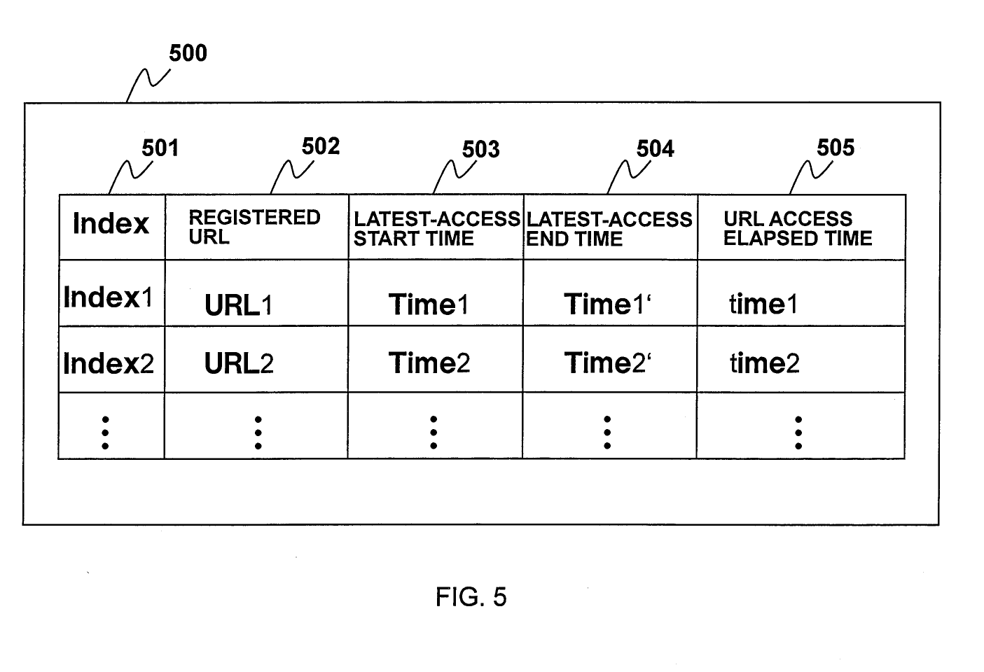

FIG. 5 is a diagram showing the structure of the access history table 500 in the communication channel switch 103.

The access history table 500 is a data table storing an index 501, a registered URL 502, a latest-access start time 503, a latest-access end time 504, and a URL access elapsed time 505 in association with one another. The index 501 is identification information of an entry in the access history table 500. The index 501 may be omitted. Like the registered URL 402 in the user registration table 400, the registered URL 502 indicates the URL of a connection destination portal site. The latest-access start time 503 indicates the access start time of the latest access to the site having the registered URL 502. The latest-access end time 504 indicates the access end time of the latest access to the site having the registered URL 502. The URL access elapsed time 505 indicates the period between the start and the end of the latest access to the site having the registered URL 502. Besides the information of the latest access, the information of past access may be stored.

In the user registration table 400 and the access history table 500, the user can specify the registered URL 402 and the registered URL 502. The other items are added, updated, and deleted in synchronization, under the control of the operation unit 300 in accordance with the registered URL 402 and the registered URL 502.

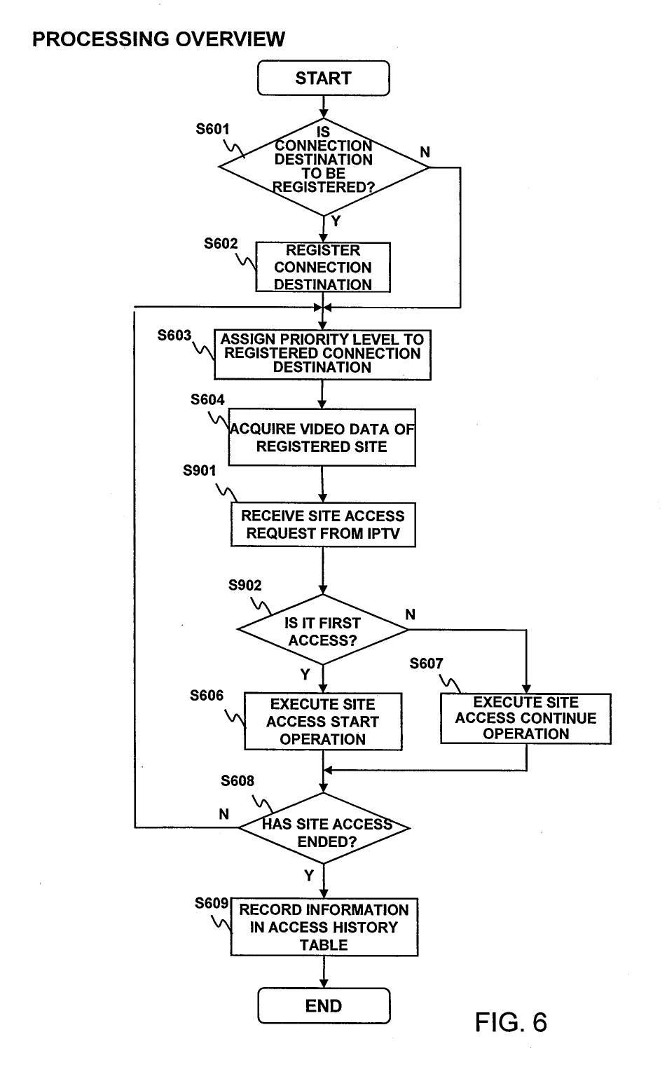

FIG. 6 shows a flowchart of the entire processing.

The processing in the embodiment includes the steps of registering a connection destination (S602), assigning a priority level to the registered connection destination (S603), acquiring registered video data (S604), performing a site access start operation (S606), performing a site access continue operation (S607), and adding information to the access history table (S609).

An overview of the entire processing will be given below in accordance with the flowchart shown in FIG. 6. The steps will be described in detail later.

The communication channel switch 103 (for example, the operation unit 300) judges whether to register a connection destination (URL) (S601). For example, the judgment can be made according to whether the connection destination registration processing is selected by the remote control 102 from the menu displayed by the IPTV 101 and whether the communication channel switch 103 receives a registration request from the IPTV 101. If it is determined to register the connection destination, the communication channel switch 103 receives the URL from the IPTV 101 and stores the received URL in the storage unit 301 (S602). If it is determined not to register the connection destination in step S601, the processing goes to step S603. On the basis of the access elapsed time 505 in the access history table 500, the communication channel switch 103 assigns a priority level to the registered connection destination (S603). The communication channel switch 103 accesses the registered URL in accordance with the priority level determined in step S603 and obtains video data 1100 (S604).

When the user attempts to access a site by using the remote control 102, the communication channel switch 103 receives an access request that includes the URL from the IPTV 101 (S901). The communication channel switch 103 judges whether the access request is made for the first access there (S902). Whether the access is a first one can be determined by checking whether the session information and packet information sent from the IPTV 101 are the URL information always recorded in the remote control 102 or IPTV 101, for example. If the access request is for the first access, the communication channel switch 103 executes the site access start operation (S606). Otherwise, the site access continue operation is executed (S607).

The communication channel switch 103 judges whether the access to the site has ended (S608). If the access to the site has ended, the communication channel switch 103 obtains the access elapsed time and stores the obtained access elapsed time in the access history table 500 (S609). If the access to the site has not yet ended, the processing returns to step S603 and continues the subsequent processing.

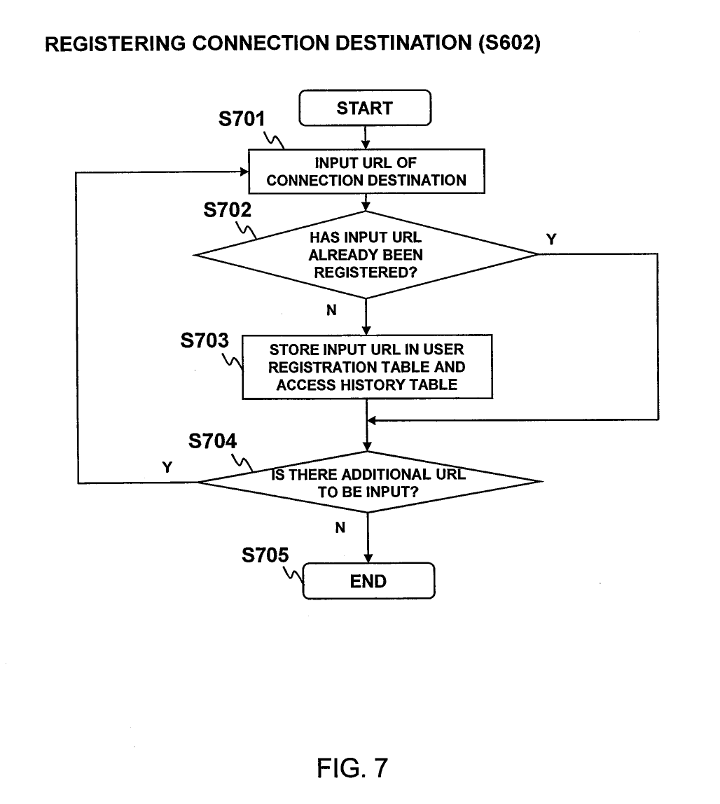

FIG. 7 shows a flowchart of processing to add a URL to the user registration table.

The processing of registering a connection destination (S602) will be described in detail first.

The communication channel switch 103 inputs the URL of a site the user wants to browse (S701). For example, the URL of the user-desired site is input by using the remote control 102, the IPTV 101 outputs it to the communication channel switch 103, and the communication channel switch 103 inputs it. The communication channel switch 103 checks whether the input URL has already been stored, with reference to the registered URL 402 in the user registration table 400 (S702). If the information has not been registered, the communication channel switch 103 adds the input URL to the user registration table 400 and the access history table 500 stored in the storage unit 301 (S703). If it is judged in step S702 that the input URL has already been stored, the processing goes to step S704.

The communication channel switch 103 judges whether there is a further URL to be added (S704). If there is a further URL to be added (S704), the communication channel switch 103 returns to step S701 and continues the subsequent processes. If there is no further URL to be added (S704), the processing ends.

The processing of assigning a priority level to a registered connection destination site (S603) will be described next.

The communication channel switch 103 assigns a higher priority level to a site having a longer elapsed time with reference to the URL access elapsed time 505, for example. For example, the operation unit 300 in the communication channel switch 103 performs sorting in descending order of the URL access elapsed time 505 in the access history table 500. There are some sorting methods such as bubblesort and quicksort. Since this embodiment requires sorting just in descending order of the URL access elapsed time 505, irrespective of sorting method, any sorting method can be used. The operation unit 300 references the registered URLs 402 in the user registration table 400 by using, as keys, the registered URLs 502 sorted in ascending order of the index 501 in the access history table 500 having entries sorted in descending order of the URL access elapsed time 505, and assigns numbers starting from ‘1’ to the corresponding priority levels 403 in ascending order.

An item having ‘0’ as the value of the URL access elapsed time 505 may be excluded from the assignment of priority levels. The operation unit 300 may assign priority levels to items having ‘0’ as the value of the URL access elapsed time 505 in the order in which they were registered in step S602 (first-in first-out).

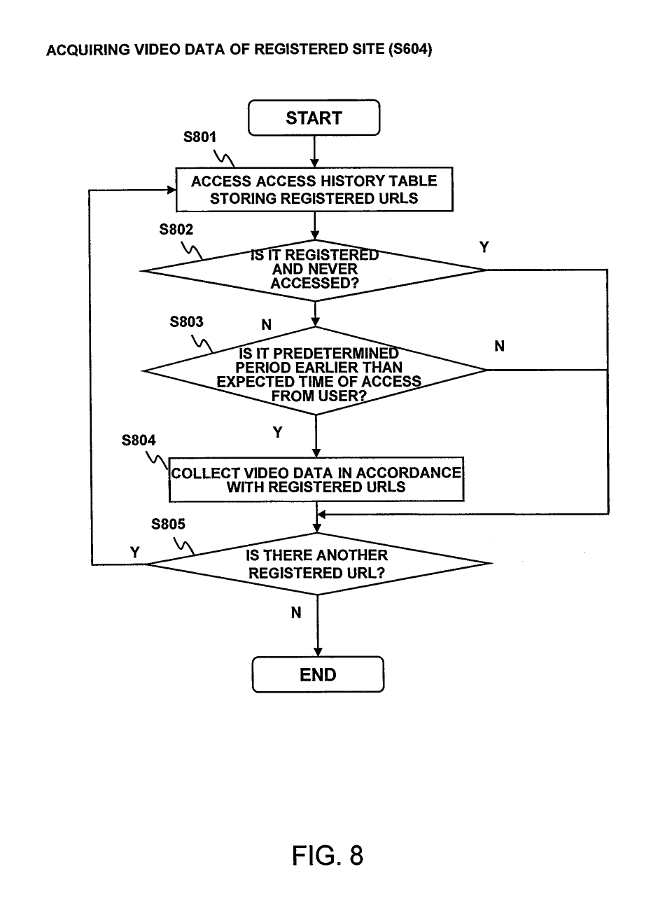

FIG. 8 shows a flowchart illustrating video data collection from a registered site.

The processing of acquiring video data of registered site (S604) will be described next.

The operation unit 300 in the communication channel switch 103 searches through the access history table 500 periodically for a match with a registered URL 402 in accordance with the priority level 403 in the user registration table 400 (S801). If the value of the URL access elapsed time 505 in the access history table 500 is ‘0’ or blank, the operation unit 300 judges that no access has been made, and does not go to acquire the video data 1100 at the URL (S802). The processing goes to step S805. If the value of the URL access elapsed time 505 in the access history table 500 is not ‘0’ (S802), the operation unit 300 judges whether the current time held by the operation unit 300 is earlier than the time obtained by adding a first predetermined reference time to the time stored as the latest-access end time 504 in the access history table 500 linked with the registered URL 402 in the user registration table 400 and whether the current time is later than the time obtained by subtracting a predetermined second reference time from the time stored as the latest-access start time 503 (S803). If Yes in step S803, the operation unit 300 collects the video data 1100 in accordance with the URL of the site in the registered URL 502 and stores the data in the storage unit 301 (S804). In other words, the communication channel switch 103 acquires the video data 1100 a predetermined period earlier than the predicted time of next access by the user according to the latest-access start time 503. However, if the predetermined period has elapsed after the latest-access end time 504, the video data 1100 are not obtained. The operation unit 300 may obtain video data from a connection destination site, according to the URLs of a predetermined number of connection destination sites in descending order of priority level. The operation unit 300 may also obtain video data from connection destination sites in descending order of priority level until the amount of data reaches a predetermined level. This can reduce the volume of traffic and can also reduce the amount of video data to be stored. The video data 1100 to be collected are some or all of the video data, depending on the capacity of the storage unit 301.

If No in step S803, the operation unit 300 does not access the site and the processing goes to step S805.

In step S805, it is judged whether there is a registered URL 502 assigned the next priority level (S805), and a return is made to step S801 to access the site. By repeating the operation for each of the registered sites, the video data of the sites registered in the user registration table 400 can be collected, and the capacity of the storage unit 301 can be used effectively.

The video data 1100 collected in the operation described above is stored in association with the URL of the site, in the storage unit 301 in the communication channel switch 103. If there is old information of the same site, the information can be overwritten to prevent the information from being duplicated. While the user is accessing a portal site, the video data 1100 of another site (URL) may be obtained in parallel.

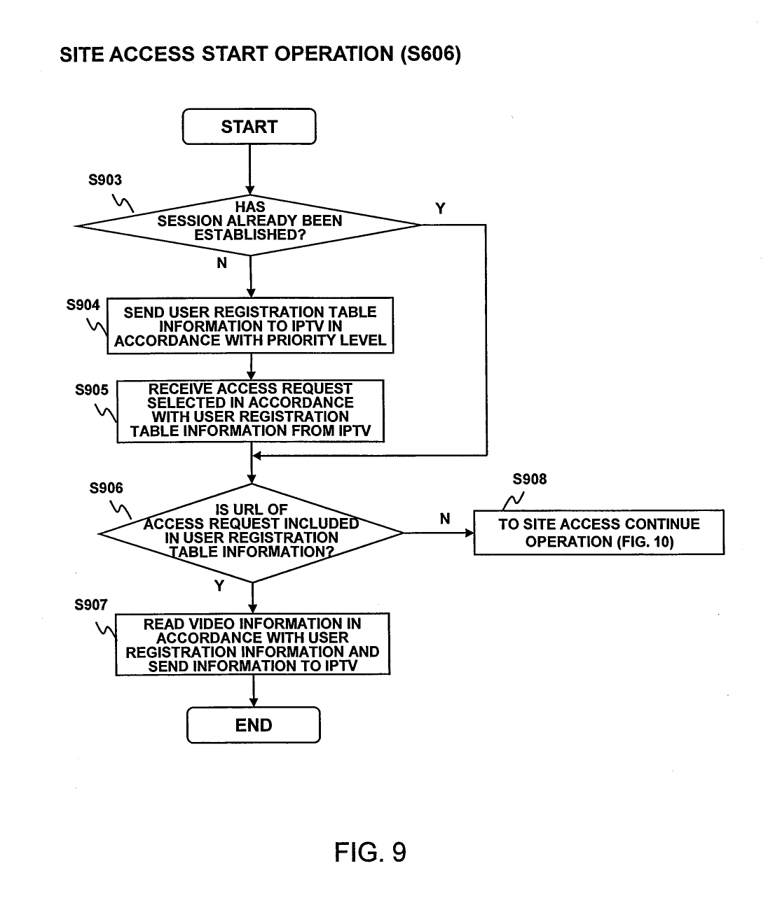

FIG. 9 shows a flowchart illustrating the access start operation.

The site access start operation (S606) will be described next.

The communication channel switch 103 judges whether a session has already been established (S903). If the session has already been established (S903), the operation goes to step S906. If the session has not been established (S903), the communication channel switch 103 sends the URL information 402 stored in the user registration table 400 held by the storage unit 301 to the IPTV 101 (S904). For example, the URLs of a predetermined number of sites are sent to the IPTV 101 in descending order of priority level. The IPTV 101 displays the received information on the screen.

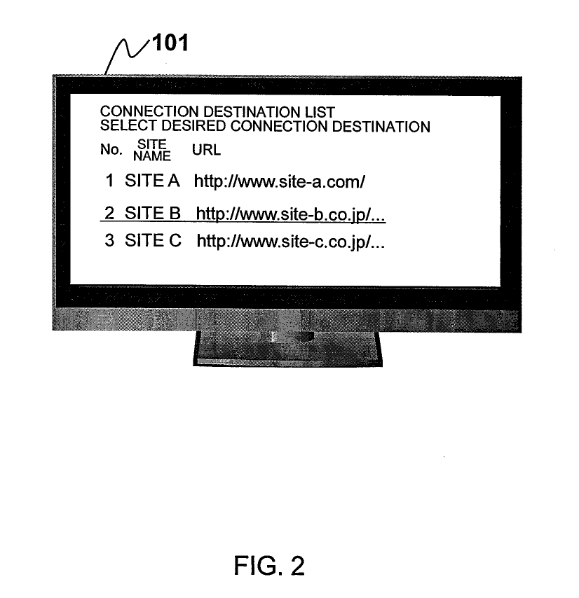

FIG. 2 shows an example of registered URLs displayed on the screen of the IPTV 101.

The user can select one of the URLs displayed on the IPTV 101 or can input a new URL without selecting any displayed URL, by using the remote control 102. When a displayed URL is selected or when a new URL is input, the IPTV 101 sends the selected or input URL to the communication channel switch 103, and the communication channel switch 103 receives the information (S905). If the received information is a selected URL (one of the URLs output to the IPTV 101), the operation unit 300 of the communication channel switch 103 checks whether the information is included in the user registration table 400 stored in the storage unit 301 (S906). If so, the corresponding video data 1100 stored in the storage unit 301 is read and sent to the IPTV 101 (S907). The IPTV 101 displays the received video data.

If a new URL is input without selecting any of the displayed URLs or if the corresponding video data 1100 is not stored (S906), the operation unit 300 executes the site access continue operation (S607) (S908). The operation unit 300 may establish a session with the site corresponding to the URL input in step S905 at an appropriate timing.

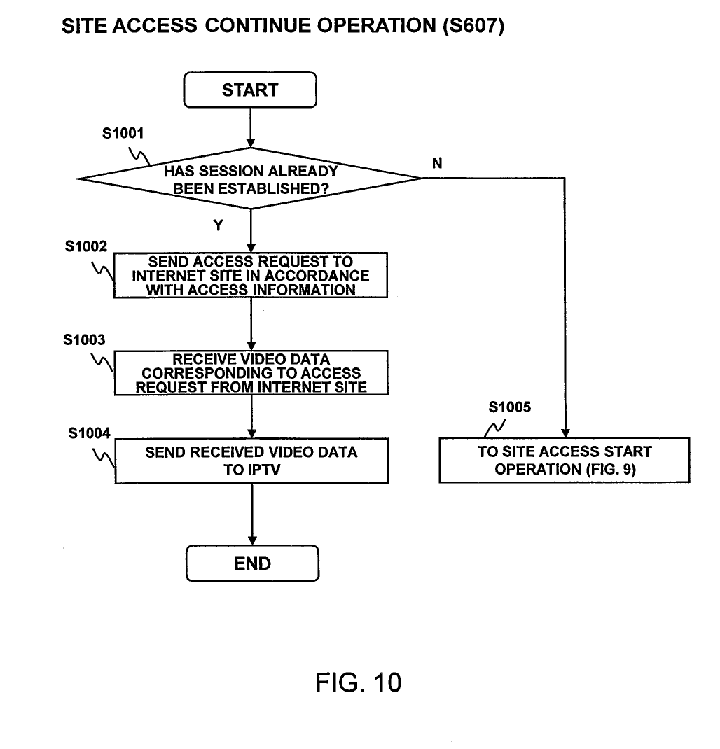

FIG. 10 shows a flowchart illustrating the site access continue operation.

The site access continue operation (S607) will be described next.

Continuous image data is assigned sequence numbers and other information, and the site is accessed at a timing when the last sequence of the data accumulated as the video data 1100 is reached.

The communication channel switch 103 judges whether a session has already been established (S1001). If a session has already been established, the received URL is sent directly to the portal site A 105, the portal site B 106, or the portal site C 107 on the Internet 104 (S1002). The site which has received the URL sends requested information through the Internet 104 to the communication channel switch 103, and the communication channel switch 103 receives the information (S1003). The communication channel switch 103 sends the received information to the IPTV 101 (S1004). Here, the received information may be sent without being subjected to any processing. The IPTV 101 displays the information received from the portal site.

If it is judged in step S1001 that a session has not been established, the communication channel switch 103 executes the site access start operation (S606) (S1005).

The processing of adding information to the access history table (S609) will be described next.

The communication channel switch 103 monitors the access status of each of the URLs held in the user registration table 400 and records it in the access history table 500. More specifically, the operation unit 300 monitors through the network input-output unit 302 information exchanged between the IPTV 101 and the portal sites A 105 to C 107 on the Internet. By doing that, the access start time and access end time of each of the URLs listed in the user registration table 400 are obtained and recorded as the latest-access start time 503 and the latest-access end time 504 in the access history table 500 in association with the registered URL 502. The operation unit 300 calculates an estimated browsing period at the URL, that is, the elapsed time from when the access to the connection destination site has started until when the access ends, by subtracting the access start time from the access end time, and records the result as the URL access elapsed time 505.

The communication channel switch 103 performs the processing of the embodiment regularly and periodically, so that the information of the site of a URL selected from the URLs listed in the user registration table 400 can be obtained more quickly than it is obtained through the Internet, independently of the URLs specified in the IPTV 101, reducing the wait period before browsing. Further, the storage capacity of the storage unit 301 in the communication channel switch 103 can be reduced to the minimum necessary level.

The present invention can be applied to a communication channel switch disposed between an Internet Protocol television receiver and a communication network, for example.

What is claimed is:

1. A communication channel switch disposed between a receiver which obtains video from a communication network and displays the video and the communication network which has connection destination sites, the communication channel switch comprising:
an access history storage unit which stores in advance an elapsed time from the start to the end of past access to each of the sites, in association with identification information of the sites;
a video data storage unit which stores video data obtained from the sites; and
an operation unit;
the operation unit determining the priority levels of the sites in accordance with the elapsed time in the access history storage unit;
obtaining video data from each of the sites in descending order of priority levels of the sites and storing the video data in the video data storage unit in association with the identification information of the sites; and
when an access request which includes identification information of a connection destination site is received from the receiver, reading the video data corresponding to the identification information from the video data storage unit and outputting the data to the receiver.

2. The communication channel switch according to claim 1, wherein the access history storage unit further stores an access start time of the past access to each of the sites in association with the identification information of the sites; and
the operation unit references the access start time in the access history storage unit in descending order of priority levels of the sites and, if the current time is a predetermined period earlier than the access start time, obtains video data from the site and stores the video data in the video data storage unit.

3. The communication channel switch according to claim 2, wherein the access history storage unit further stores an access end time of the latest access to each of the sites in association with the identification information of the sites; and
the operation unit references the access end time of the latest access in the access history storage unit and, if a predetermined period or longer has elapsed since the access end time of the latest access, decides not to obtain video data from the site.

4. The communication channel switch according to claim 3, wherein the operation unit stores the access start time and access end time of access to each of the sites in the access history storage unit in association with the identification information of the sites; and
obtains an elapsed time at each of the sites, from the access start time and the access end time, and stores the elapsed time in the access history storage unit in association with the identification information of the site.

5. The communication channel switch according to claim 1, further comprising:
a user registration information storage unit which stores identification information of a plurality of connection destination sites to be used when the sites are accessed, in association with the priority level of each of the sites; wherein:
the operation unit stores identification information of an input connection destination site and a determined priority level in the user registration information storage unit;
outputs to and displaying on the receiver the identification information of a predetermined number of sites in descending order of priority level among from the identification information of the plurality of connection destination sites stored in the user registration information storage unit; and
receives from the receiver the access request which includes the identification information selected from the displayed identification information of the sites, reads the video data corresponding to the identification information of the site from the video data storage unit, and outputs the data to the receiver.

6. The communication channel switch according to claim 1, wherein the operation unit obtains video data from a predetermined number of connection destination sites in descending order of priority level in accordance with the identification information of the sites.

7. The communication channel switch according to claim 1, wherein the operation unit obtains video data from the connection destination sites in descending order of priority level until the amount of stored data reaches a predetermined level.
